(19) United States
(12) Patent Application Publication
(10) Pub. No.: US 2006/0168663 A1
(43) Pub. Date: Jul. 27, 2006

(54) Secure transaction protocol

(76) Inventors: Andre F. Viljoen, North Vancouver (CA); Robin B. Hutchison, South Surrey (CA); Robert C. Llewellyn, Poulsbo, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/172,149

(22) Filed: Feb. 27, 2002

Related U.S. Application Data
(63) Continuation of application No. 09/866,528, filed on May 25, 2001, now abandoned.
(60) Provisional application No. 60/206,960, filed on May 25, 2000.

(51) Int. Cl. H04L 9/32; G06F 17/30

(52) U.S. Cl. 726/27

(57) ABSTRACT

A system for engaging in secure transactions over an internetwork, involving, a consumer, a merchant and a Transaction Authority as parties to a transaction. To initiate the transaction the consumer makes an inquiry with the merchant who then returns a signed offer. The consumer then accepts the offer by also signing the offer. The doubly signed offer is then forwarded to the Transaction Authority. The Transaction Authority validates the transaction by checking both the authority and identity of the merchant and the consumer. The Transaction Authority then signs the offer to create a triply signed offer. The Transaction Authority returns the triply signed offer to the merchant. Once the merchant has a validated offer they are then able to request settlement of the transaction from the Transaction Authority, either immediately, or at some future date by sending a settlement request to the Transaction Authority.

### CROSS-REFERENCE TO RELATED APPLICATION

This application claims the benefit of Provisional Application No. 60/206,960, filed May 25, 2000, the benefit of which is hereby claimed under 35 U.S.C. § 119. The entire disclosure of the prior application is considered as being part of the disclosure of this application and is hereby incorporated by reference herein.

### FIELD OF THE INVENTION

This invention generally relates to a method and apparatus for engaging in secure transactions between one or more other computers connected via common communications links and, more particularly, to a method and apparatus for engaging in secure transactions between computers connected to the Internet using a secure transaction account.

### BACKGROUND OF THE INVENTION

Communication networks are well known in the computer communications field. By definition, a network is a group of computers and associated devices that are connected by communications facilities or links. Network communications can be of a permanent nature, such as via cables, or can be of a temporary nature, such as connections made through telephone or radio links. Networks may vary in size, from a local area network (“LAN”) consisting of a few computers or workstations and related devices; to a wide area network (“WAN”) which interconnects computers and LANs that are geographically dispersed; to a remote access service (“RAS”) which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “Internet.” As currently understood, the capitalized term “Internet” refers to the collection of networks and routers that use the Transmission Control Protocol/Internet Protocol (“TCP/IP”) to communicate with one another.

A representative section of the Internet 40 is shown in FIG. 1 (Prior Art) in which a plurality of local area networks 44 and a wide area network 46 are interconnected by routers 42. The routers 42 are generally special purpose computers used to interface one LAN or WAN to another. Communication links within the LANs may be twisted wire pair, or coaxial cable, while communication links between networks may utilize 56 Kbps analog telephone lines, or 1 Mbps digital T-1 lines and/or 45 Mbps T-3 lines. Further, computers and other related electronic devices can be remotely connected to either the LANs 44 or the WAN 46 via a modem and temporary telephone link. Such computers and electronic devices 48 are shown in FIG. 1 as connected to one of the LANs 44 by a dotted line. It will be appreciated that the Internet comprises a vast number of such interconnected networks, computers and routers and that only a small, representative section of the Internet 40 is shown in FIG. 1.

The Internet has recently seen explosive growth by virtue of its ability to link computers located throughout the world. As the Internet has grown, so has the World Wide Web (“Web”). The Web is a vast collection of interconnected or “hypertext” documents (also known as “Web pages”) written in HyperText Markup Language (“HTML”) that are electronically stored at “Web sites” throughout the Internet. A Web site is a server connected to the Internet that has mass storage facilities for storing hypertext documents and that runs administrative software for handling requests for those stored hypertext documents. A hypertext document normally includes a number of hyperlinks, i.e., highlighted portions of text that link the document to another hypertext document possibly stored at a Web site elsewhere on the Internet. Each hyperlink is associated with a Uniform Resource Locator (“URL”) that provides the exact location of the linked document on a server connected to the Internet. Thus, whenever a hypertext document is retrieved from any Web server, the document is considered to be retrieved from the Web.

A user is allowed to retrieve hypertext documents from the Web, i.e., a user is allowed to “surf the Web,” via a Web browser. A Web browser, such as NETSCAPE NAVIGATOR® or MICROSOFT® Internet Explorer, is a software program implemented by a Web client, i.e., a user's computer, to provide a graphical user interface to the Web. Upon request from the user via the Web browser, the Web client accesses and retrieves the desired hypertext document or Web page from the appropriate Web server using the URL for the document and a protocol known as HyperText Transfer Protocol (“HTTP”). HTTP is a higher-level protocol than TCP/IP and is designed specifically for the requirements of the Web. It is used on top of TCP/IP to transfer hypertext documents between servers and clients.

At the advent of the Web, the information stored on the Internet was freely transferred back and forth between those parties interested in the information. However, the Web is quickly becoming a channel of commercial activity, whereby a vast number of companies have developed their own Web sites for advertising and selling their goods and services. Commercial activity that takes place by means of connected computers is known as electronic commerce, or e-commerce, and can occur between a consumer and a merchant through an on-line information service, the Internet, a bulletin board system (“BBS”), or between consumer and merchant computers through electronic data interchange (“EDI”). A consumer (also referred to as a user, consumer or purchaser in the context of e-commerce) may “visit the Web site” of a company or merchant, i.e., retrieve the hypertext documents located on the Web server of a particular merchant, and order any good or service that the merchant has to offer. If that good or service is in the form of electronically stored information, such as a book, a video, a computer game, etc., the consumer may simply download the good or service from the company's Web site to his or her computer for immediate consumption and use. If the good or service is of a more tangible nature, such as an appliance or article of clothing ordered from an on-line catalog, a more conventional method of delivery, e.g., the postal service or a common carrier, is used.

A common method of engaging in electronic transactions is electronic credit, or c-credit. E-credit is a form of electronic commerce often involving credit card transactions carried out over the Internet. Traditional e-credit purchases are paid for by a major credit card, wherein the consumer is required to transmit his or her credit information, for example, an account number and expiration date, over the Internet to the company's Web site. Many consumers are concerned about the security and confidentiality of such electronic transmissions. Furthermore, many consumers do not have a major credit card with which to make such purchases. Alternative billing systems, such as providing credit information by facsimile or postal service, are much less convenient and often prove enough of a barrier to prohibit the sale altogether. Finally, the traditional methods of billing and payment do not adequately protect the merchant or consumer from fraudulent purchases.

Accordingly, a more effective method and apparatus for providing secure transactions for goods, services, content and other desirables over a network, and ultimately the Internet, is needed. The method and apparatus should protect the merchant and consumer from fraudulent purchases. Additionally, the method and apparatus should provide an element of non-repudiation to all transactions.

### SUMMARY OF THE INVENTION

The present invention provides a method and system for implementing and using a secure transaction protocol for authenticating transactions between a plurality of computers. A typical secured transaction would be used when a consumer and a merchant wish to engage in some form of remote commercial transaction. The consumer wishes to receive something that the merchant wishes to provide, but both parties want the other to be bound once they have committed to the transaction. Each party also wishes to know with whom they are dealing. Additionally, each party wants to know all the terms of the transaction and that the other party has not altered or deviated from the terms in any manner. Finally, each party also wants to know that once both have agreed to the transaction that neither can deny they agreed to the transaction. By providing authentication, integrity and non-repudiation, the present invention is able to fulfill these wishes between the consumer and merchant.

According to one exemplary embodiment of the present invention, a consumer, a merchant and a Transaction Authority are parties to a transaction. To initiate the transaction the merchant sends a request for a transaction identifier to the Transaction Authority. The Transaction Authority then generates a new transaction identifier. The Transaction Authority then sends the transaction identifier back to the merchant. The merchant then creates an “offer” that includes the transaction identifier and sends the offer to the consumer. Before responding to the offer, the consumer sends an account list request to the Transaction Authority. The Transaction Authority authenticates the request and then constructs an account list of all accessible accounts for the consumer and sends the account list back to the consumer. The consumer receives the account list and then chooses an accessible account to use in the current transaction. Using the chosen account, the consumer responds to the merchant with an accepted purchase contract. Once the merchant has an accepted purchase contract, they forward it to the Transaction Authority who validates the contract and returns the validated contract back to the merchant. Once the merchant has a validated contract they are then able to request settlement of the transaction from the Transaction Authority, either immediately, or at some future date by sending a settlement request to the Transaction Authority. Once the Transaction Authority receives a settlement request, the request is checked for validity and if it is valid, the Transaction Authority responds in the manner called for in the settlement request, usually sending back a settlement response to the merchant.

In accordance with yet other aspects of the present invention, a secure transaction account can have associated sub-accounts. A sub-account can have a limited authority that is less than the main account credit limit. A sub-account may limit the merchant sites from which transactions may be engaged.

In accordance with further aspects of the present invention, purchases must be made by a registered consumer from a registered merchant. Security is ensured via authentication of the parties to a transaction. Authentication can be performed by verification of a digital certificate, or a digital signature, or by alternate authentication methods.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 (Prior Art) is a block diagram of a representative portion of the Internet;

FIG. 2 is a pictorial diagram of a network (LAN) connected via the Internet for engaging in transactions by a consumer using a device located on the Internet in accordance with the present invention;

FIG. 3 is a block diagram of several components of the consumer device shown in FIG. 2 for engaging in secure transactions in accordance with the present invention;

FIG. 4 is a block diagram of several components of the merchant server shown in FIG. 2 for engaging in secure transactions in accordance with the present invention;

FIG. 5 is a block diagram of several components of the transaction server shown in FIG. 2 for engaging in secure transactions in accordance with the present invention;

FIGS. 6-8 are exemplary windows displayed on a consumer device when engaging in a secure transaction in accordance with the present invention;

FIG. 9 is a flow diagram illustrating the logic used by the consumer device to engage in transactions using the Web browser;

FIG. 10 is a flow diagram illustrating the logic used by an authenticator to validate that an account holder is a registered secure transaction account participant;

FIG. 11 a flow diagram illustrating the logic used by a transaction server adapter to engage in a secure transaction using the transaction server;

FIG. 12 is a flow diagram illustrating the logic used by the transaction service of the transaction server shown in FIG. 5 to process and validate a secure transaction;

FIG. 13 is a diagram illustrating the actions taken by the consumer device, the merchant server and the transaction server to order goods, services and/or content using the secure transaction account;

FIG. 14 is a flow diagram illustrating the logic used by the merchant server to perform a settlement transaction, (e.g., initiate transfer of funds);

FIGS. 15-16 are exemplary Web pages used by a merchant to view transaction reports;

FIG. 17 is a flow diagram illustrating the logic used to authenticate a merchant and generate a report for the merchant.

### DETAILED DESCRIPTION OF THE PREFERRED EMBODIMENT

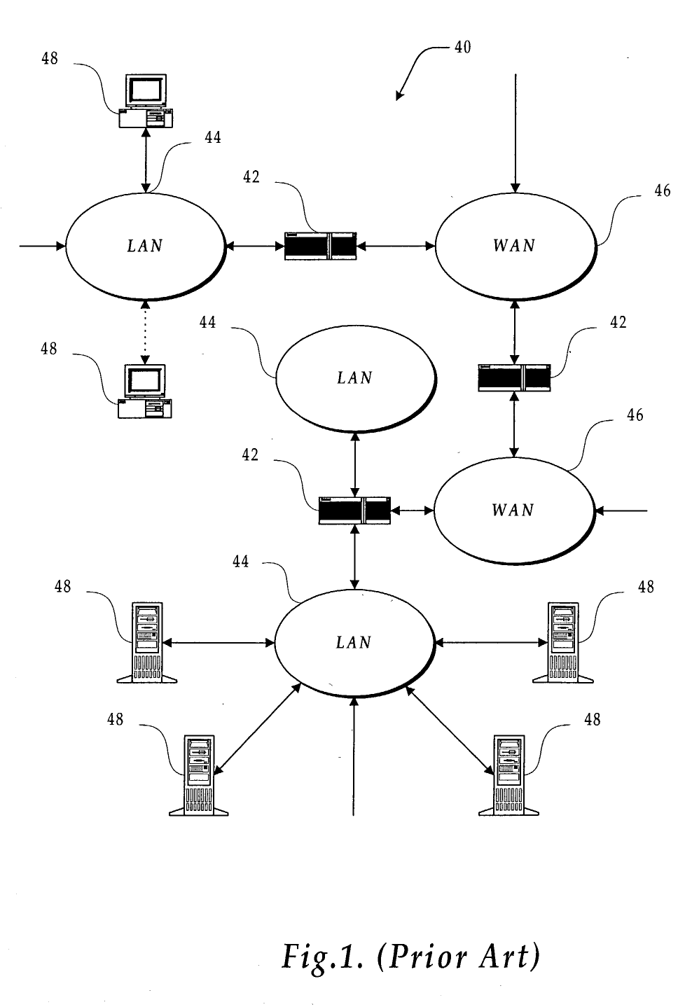

As previously described and shown in FIG. 1, the Internet 40 is a collection of local area networks 44, wide area networks 46, remote computers 48 and routers 42 that use the Transmission Control Protocol/Internet Protocol to communicate with each other. The World Wide Web, on the other hand, is a vast collection of interconnected, electronically stored information located on servers connected throughout the Internet 40. Many companies are now selling goods, services and access to their premium content over the Internet using the Web. In accordance with the present invention, a consumer engages in secure transaction over the Internet 40 via a Web browser using his or her secure transaction account without transferring sensitive personal information, over the Internet 40.

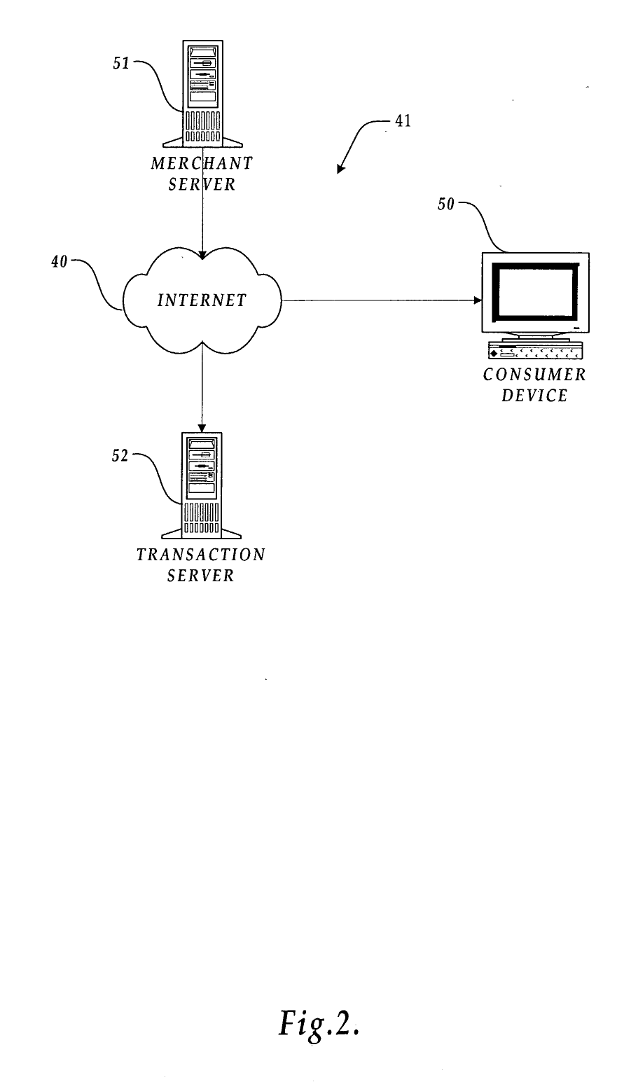

More specifically, as shown in FIG. 2, the transactions by the consumer may involve goods, services, and/or premium content from a merchant server 51, i.e., a computer owned by the merchant engages in secure transactions with the consumer, by placing an order with the merchant server 51 from a consumer device 50 connected to the Internet 40. The transaction is processed and confirmed by a transaction server 52 connected to network 41 via the Internet 40.

In the exemplary embodiment of the present invention shown in FIG. 2, the network 41 may be formed of various coupling media such as glass or plastic fiber-optics cables, coaxial cables, twisted wire pair cables, ribbon cables, etc. In addition, one of ordinary skill in the art will appreciate that the coupling medium can also include a radio frequency coupling media or other intangible coupling media. Any computer system or number of computer systems, which is equipped with the necessary interface hardware may be connected temporarily or permanently to the network 41, and thus, the Internet 40. However, if temporarily connected via a telephone link to another device connected to the network 41, the interface hardware of both the remote computer 48 and the device to which it is connected will contain a modem.

Finally, those of ordinary skill in the art will recognize that while only one consumer device 50, and one merchant server 51 are depicted in FIG. 2, numerous consumer devices and merchant servers equipped with the hardware and software components described below may be connected to the network 41. It will also be appreciated that the term “consumer” used herein can be applied to any person engaged in a transaction and can be applied equally to an individual, non-commercial purchaser, a business or a commercial purchaser. In other words, the term “consumer” can apply to any consumer and the term “merchant” can apply to any vendor or merchant, be they an individual, non-commercial seller, a business or a commercial seller.

### Relevant Consumer Device, Merchant Server, Transaction Server, and Credit Processing Server Components

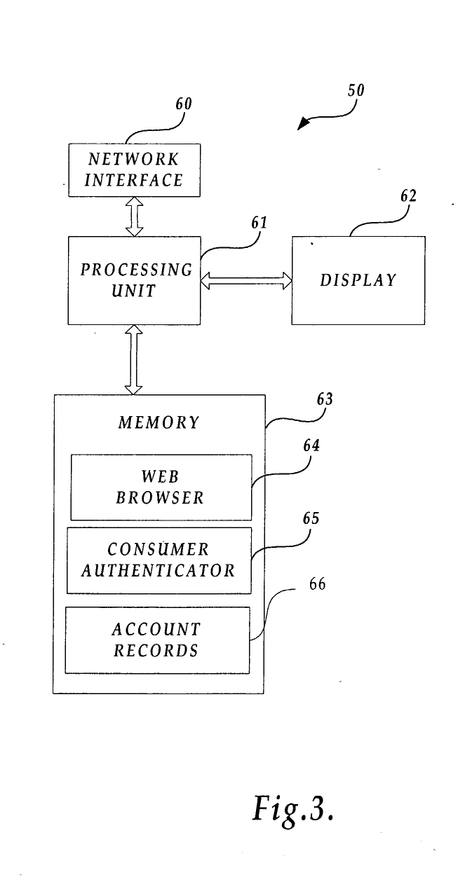

FIG. 3 depicts several of the important components of the consumer device 50. Those of ordinary skill in the art will appreciate that the consumer device 50 could be any computing device, including but not limited to workstations, personal computers, laptop computers, personal data assistants, servers, remote computers, etc., used by the consumer to utilize the consumer's secure transaction account. Additionally, those of ordinary skill in the art will appreciate that the consumer device 50 may include many more components than those shown in FIG. 3. However, it is not necessary that all of these generally conventional components be shown in order to disclose an illustrative embodiment for practicing the present invention. As shown in FIG. 3, the consumer device 50 includes a network interface 60 for connecting to a LAN 44 or WAN 46, or for connecting remotely to a LAN 44 or WAN 46. Those of ordinary skill in the art will appreciate that the network interface 60 includes the necessary circuitry for such a connection, and is also constructed for use with the TCP/IP protocol, and/or the particular network configuration of the LAN or WAN it is connecting to, and a particular type of coupling medium.

The consumer device 50 also includes a processing unit 61, a display 62 and a memory 63. The memory 63 generally comprises a random access memory (“RAM”), a read-only memory (“ROM”) and a permanent mass storage device, such as a disk drive, tape drive, optical drive, floppy disk drive, or combination thereof. The memory 63 stores the program code and data necessary for ordering and paying for a product over the Internet 40 in accordance with the present invention. More specifically, the memory 63 stores a Web browser component 64, such as NETSCAPE NAVIGATOR® or MICROSOFT® Internet Explorer, a consumer authenticator component 65 formed in accordance with the present invention for authenticating a consumer as a registered participant of the secure transaction system prior to performing any secure transaction account transactions, and account records 66 for maintaining the information on the consumer's accounts. It will be appreciated that these components may be stored on a computer-readable medium and loaded into memory 63 of the consumer device 50 using a mechanism associated with the computer-readable medium, such as a floppy, DVD/CD-ROM drive, or the network interface.

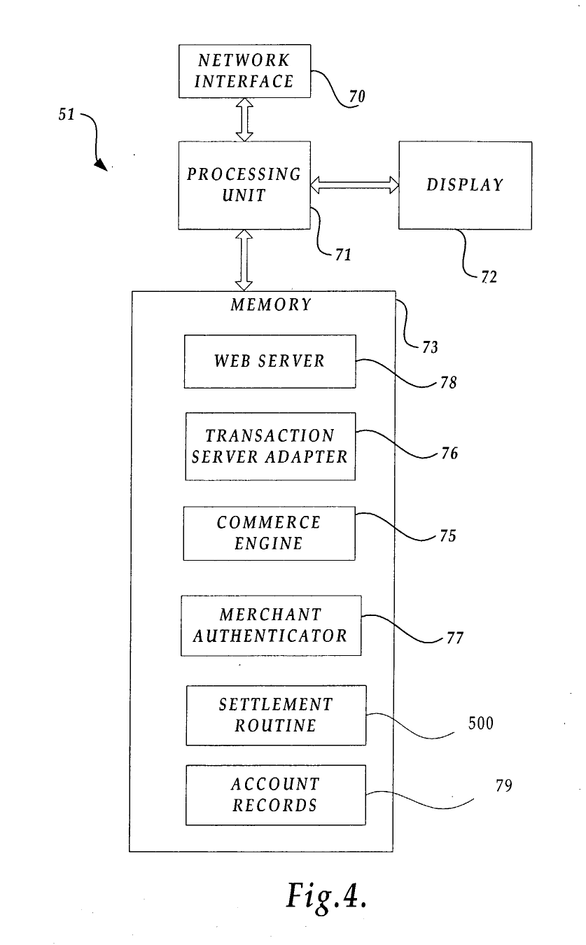

As will be described in more detail below, the products ordered by the consumer are supplied by a merchant server 51, described next, following authorization from a remote server, i.e., a transaction server 52 described later, located elsewhere on the Internet, e.g., as illustrated in FIG 2. FIG. 4 depicts several of the important components of the merchant server 51. Those of ordinary skill in the art will appreciate that the merchant server 51 includes many more components than those shown in FIG. 4. However, it is not necessary that all of these generally conventional components be shown in order to disclose an illustrative embodiment of practicing the present invention. As shown in FIG. 4, the merchant server 51 includes a network interface 70 for connecting to a LAN 44 or WAN 46, or for connecting remotely to a LAN 44 or WAN 46. Those of ordinary skill in the art will appreciate that the network interface 70 includes the necessary circuitry for such a connection, and is also constructed for use with the TCP/IP protocol, the particular network configuration of the LAN or WAN it is connecting to, and a particular type of coupling medium.

The merchant server 51 also includes a processing unit 71, a display 72 and a memory 73. The memory 73 generally comprises a RAM, ROM, and a permanent mass storage device, such as a hard disk drive, tape drive, optical drive, floppy disk drive, or combination thereof.

The memory 73 also contains a commerce engine component 75 for purchasing a product from a merchant Web site. The commerce engine component 75 may be an existing commerce engine, such as MICROSOFT® Site Server, which allows for the payment of products ordered over the Internet using a major credit card, e.g., VISA® or MASTERCARD®. A transaction server adapter 76 is also provided to allow the commerce engine component 75 to interface with the transaction server 52. The transaction server adapter 76 uses and provides application programming interface (API) calls to interface with the commerce engine 75. Also included in memory is a merchant authenticator component 77 for verifying that the merchant is an authorized or registered merchant of the secure transaction system of the present invention and merchant account records 79. It will be appreciated that the commerce engine component 75, the transaction server adapter 76, the merchant authenticator component 77 and the merchant account records 79 may be stored on a computer-readable medium and loaded into memory 73 of the merchant server 51 using a mechanism associated with the computer-readable medium, such as a floppy, DVD/CD-ROM drive, or the network interface 70. Finally, memory 73 stores a Web server component 78 for handling requests for stored information received via the Internet and the Web.

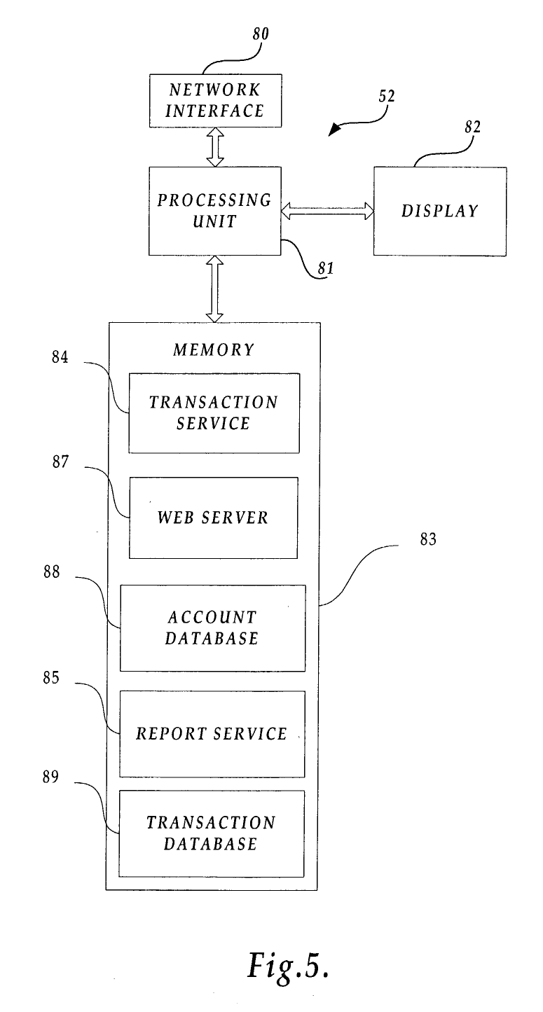

FIG. 5 depicts several of the important components of the transaction server 52. Those of ordinary skill in the art will appreciate that the transaction server 52 includes many more components than those shown in FIG. 5. However, it is not necessary that all of these generally conventional components be shown in order to disclose an illustrative embodiment for practicing the present invention. As shown in FIG. 5, the transaction server 52 include a network interface 80 for connecting to a LAN 44 or WAN 46, or for connecting remotely to a LAN or WAN. Those of ordinary skill in the art will appreciate that the network interface 80 includes the necessary circuitry for such a connection, and is also constructed for use with the TCP/IP protocol, the particular network configuration of the LAN or WAN it is connecting to, and a particular type of coupling medium.

The transaction server 52 also includes a processing unit 81, a display 82 and a memory 83. The memory 83 generally comprises a RAM, a ROM, and a permanent mass storage device, such as a hard disk drive, tape drive, optical drive, floppy disk drive, or combination thereof. The memory 83 stores the program code and data necessary for authorizing transactions between merchants and consumers in accordance with the present invention. More specifically, the memory 83 stores a transaction service component 84 formed in accordance with the present invention. An account database 88 and a transaction database are also stored in memory 83 for maintaining records of consumer and merchant accounts and transactions. A report service component 85 is also stored in memory 83 for processing requests for reports and consolidating information for requested reports. It will be appreciated that the transaction service component 84, the report service component 85, transaction database 89, and the account database 88 may be stored on a computer-readable medium and loaded into memory 83 of the transaction server 52 using a drive mechanism associated with the computer-readable medium, such as floppy, DVD/CD-ROM drive, or network interface 80. The memory 83 also stores a Web server component 87 for handling requests for stored information received via the Internet 40 and the Web.

FIGS. 3-5 depict important components of the consumer device 50, merchant server 51, and transaction server 52 shown in FIG. 2 of one exemplary embodiment of the present invention. It will be appreciated that many other implementations and variations are possible. For example, one or more of the sub-systems 84, 85, 87 or 88 could be in separate servers. Further, additional transaction servers 52 may be located on the LAN 44 or elsewhere on the Internet 40.

Once an account is set up (through any method of account set up as is known in the art), the secure transaction system of the present invention is a closed system that provides consumers a secure method for engaging in transactions over the Internet. The closed system may include only a consumer device 50, a merchant server 51 and the transaction server 52 (administered by the Transaction Authority of the secure transaction system). Since the account information necessary for authenticating the consumer for the transaction is already in the account database 88 of the transaction server 52 the closed system of the present invention allows consumers to engage in secure transactions with merchants without transferring sensitive account information to the merchants over the Internet.

### Digital Security

The illustrated embodiment also allows a consumer to create a custom package of sub-accounts. As will be readily recognized by those of ordinary skill in the art, the consumer may be provided with any number, type or combination of sub-accounts depending on the desires of those providing and administrating the secure transaction system of the present invention. Either a main account or all accounts will have an associated digital certificate signed by the Transaction Authority.

It will be appreciated that the digital certificate may be stored in the memory 63 of the consumer device 50 (e.g., in the account records 66), or on some form of device capable of interfacing with the consumer device such as, but not limited to, a secure token, smart card or as an encrypted file available from some other computer readable medium.

Once the secure transaction account has been registered, a digital certificate is transferred by the transaction server 52 and installed on the consumer device 50 or other device in communication with the consumer device 50. The digital certificate is then used in subsequent transactions as a unique credential to identify the consumer as a holder of a secure transaction account. In an actual embodiment of the present invention, a consumer or merchant is identified as account holder of the secure transaction system by the transaction server 52 verifying the Transaction Authority's digital signature on the digital certificate associated with the secure transaction account.

It will be appreciated that several levels of security can be imposed on secure transactions. Moving from the lower level security to the higher level security, there can be: (A) no security restrictions imposed; (B) minimal security, such as account name and password verification; (C) intermediate security, such as a digital certificate or secret key; (D) high security, such as a transaction signed with a digital signature using the consumer's secret key; or (E) maximum security, such as a digital signature and additional access controls, such as an account number, a last purchase verification, smart cards, secure tokens or some combination thereof. As will be described later, in one actual embodiment of the secure transaction system described herein, the term “digital certificate” is used to describe the authorization used; however, it will be appreciated that a higher level of security such as multiple digital signatures, or a digital signature with additional access controls may be desired in order to ensure the highest level of security for all parties involved (i.e., the consumer, the merchant and the transaction server in secure transactions.

### Secure Transactions

In one exemplary embodiment of the secure transaction, the merchant server 51 digitally signs a transaction offer with a certificate issued by the transaction server 52 and sends it to the consumer device 50; the consumer device 50 digitally signs the transaction offer with a certificate issued by the transaction server 52 and sends it back to the merchant server 51; the merchant server 51 then forwards the doubly signed purchase offer to the transaction server 52; the transaction server 52 verifies both signatures and if they are both valid and the transaction is permissible then signs the doubly signed offer and returns the resulting triply signed purchase offer to the merchant server 51; the merchant server verifies the transaction server's 52 signature, and if it is valid, then the purchase transaction is complete. In the aforementioned example, the merchant server 51 may notify the consumer device 50 or it may not.

Once a consumer has his or her secure transaction account, he or she can immediately engage in secure transactions with merchants who also have accounts. If, however, the consumer's secure transaction account is only a prepaid account, prepayment must be made before the consumer can order products. In an alternate embodiment, the consumer with only a prepaid account can order products. However, shipment of the product will be held until the payment has been made. It will be appreciated that in yet another embodiment, consumer and merchant will use the same type of secure transaction accounts and that any consumer can therefore act as a merchant and vice versa. Additionally, it will be appreciated that a merchant can be an auction Web site in which a consumer uses his or her secure transaction account to pay for the goods, services and/or content purchased from the auction Web site, or may simply use the secure transaction account to form the agreement upon which a winning bid is secured. Therefore, even though the transaction is with a seller who does not have an account, the merchant acts on behalf of the seller in the auction.

In one actual embodiment of the present invention, the consumer may “surf the Web” and visit a merchant's Web site, using the Web browser 64. Once the consumer has selected the desired transaction, the consumer indicates a desire to start the transaction, for example, by clicking an “OK” or a “Buy” button.

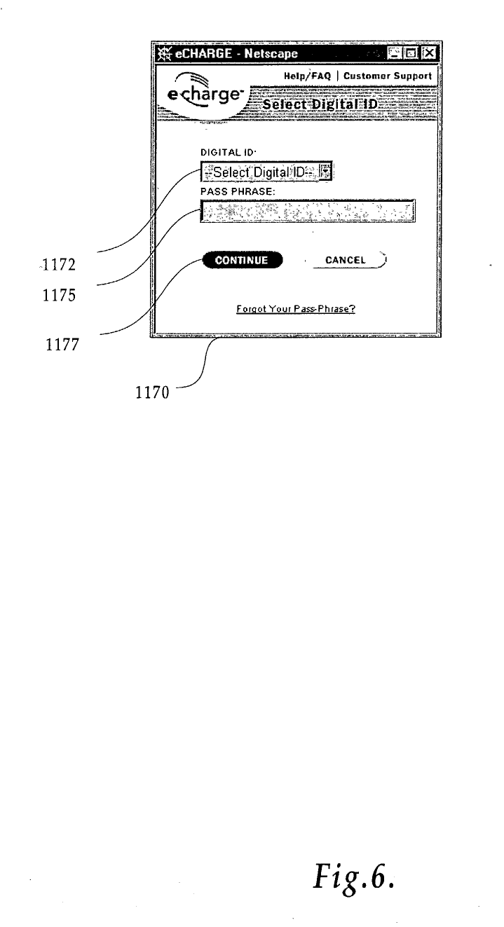

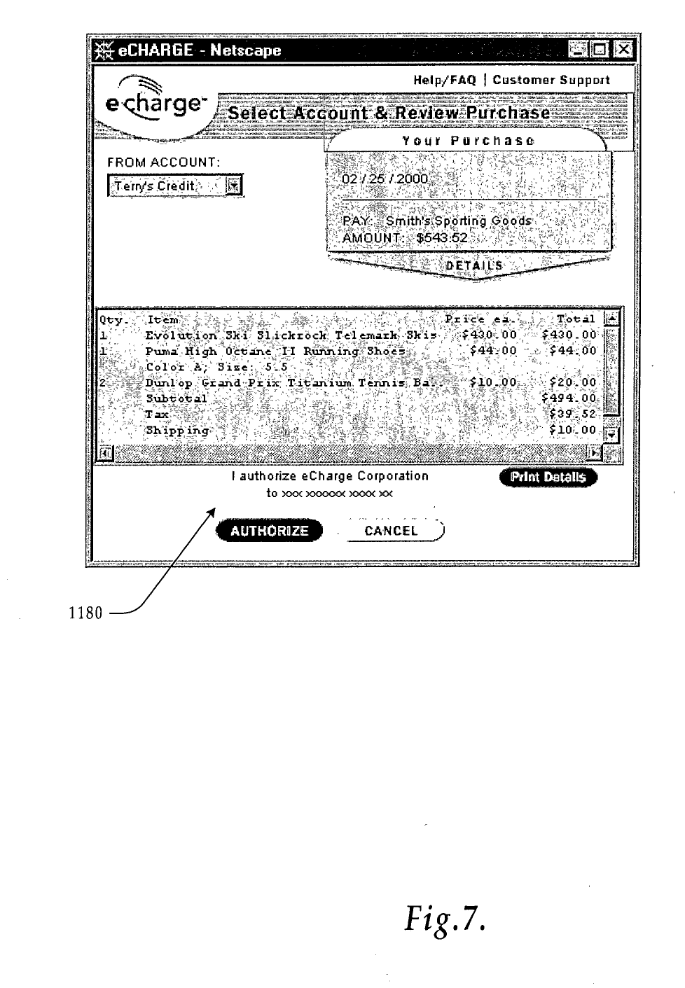

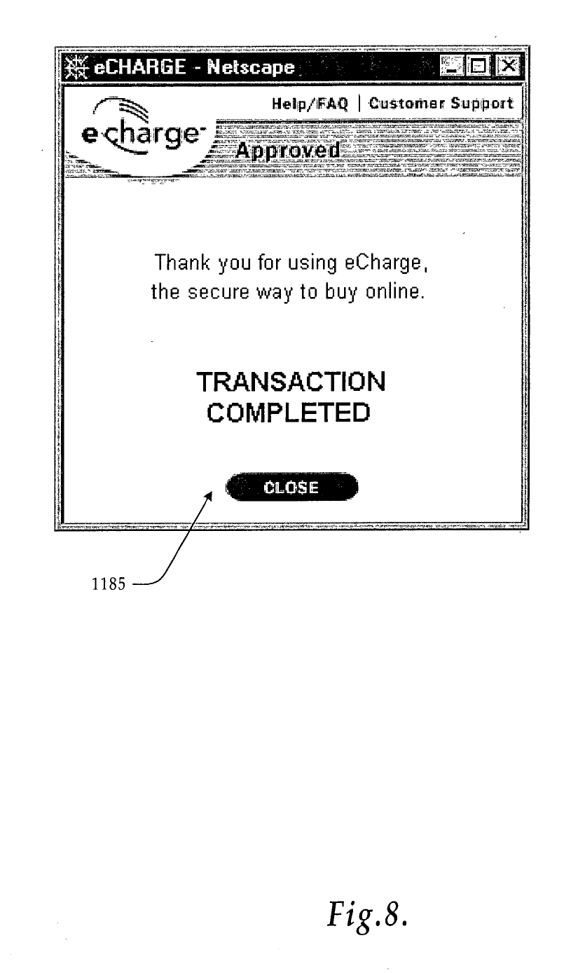

After initiating the secure transaction, as depicted in FIGS. 6-8, the consumer authenticator 65 displays a window 1170 requesting the consumer to select their choice of accounts 1172, along with an authenticating pass phrase 1175. After selecting an account and entering the correct pass phrase, the consumer clicks “Continue” 1177 to proceed with the transaction. After authorizing the transaction, such as the transaction illustrated in window 1180, the consumer may be presented with a transaction confirmation screen 1185 as shown in FIG. 8.

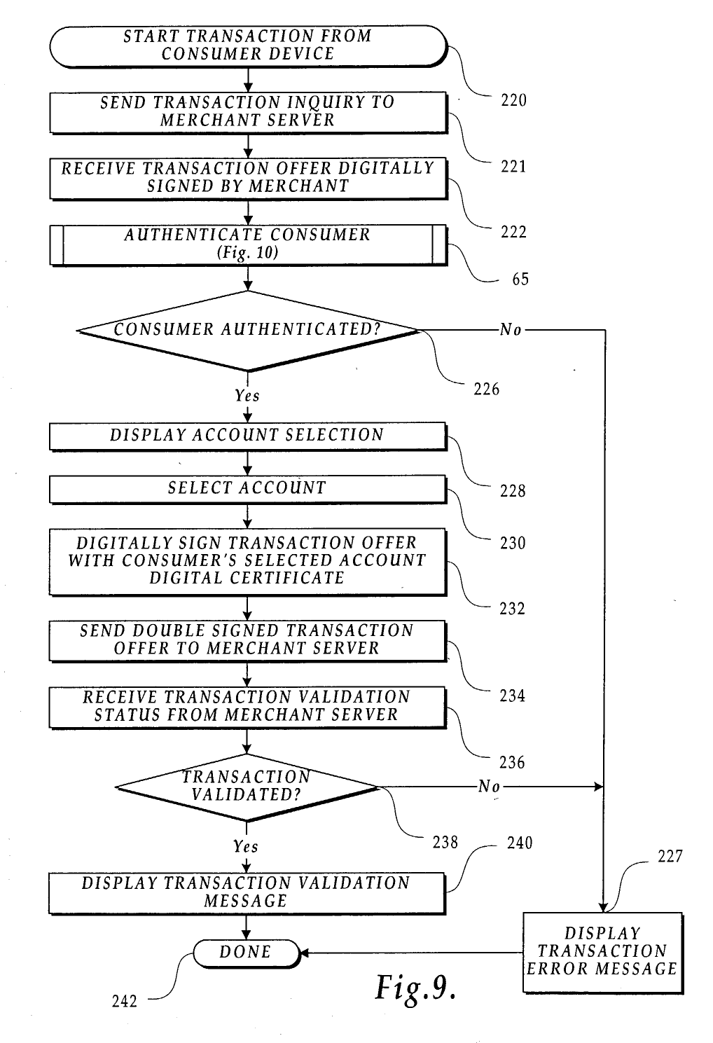

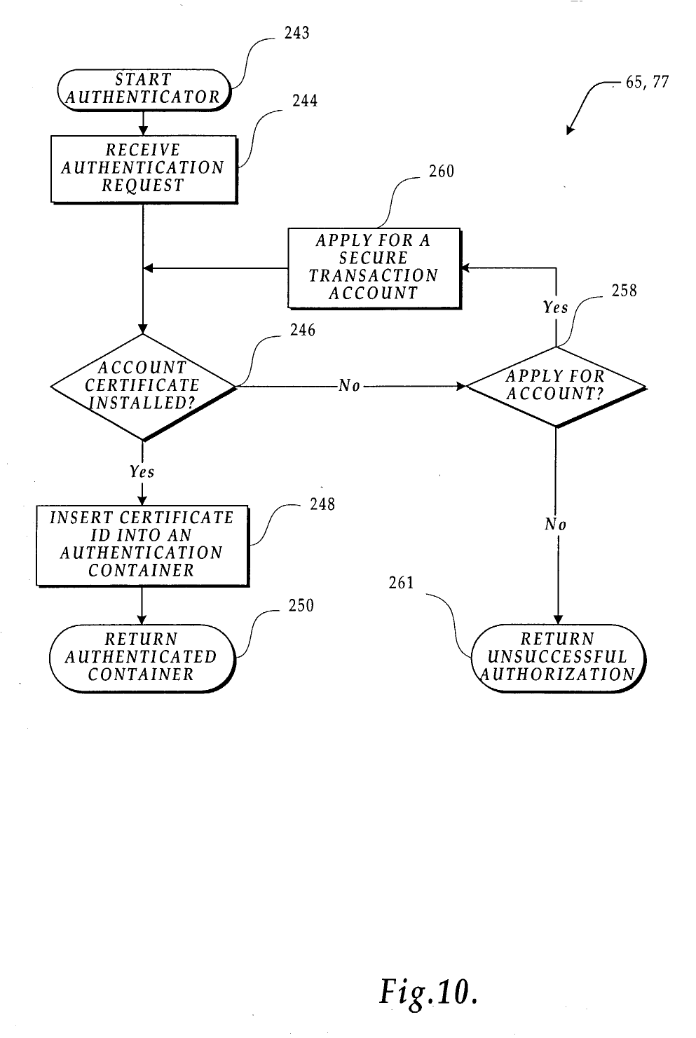

FIG. 9 illustrates logic implemented using the Web browser 64 installed on the consumer device 50 to engage in secure transactions. The logic begins in a block 220 and proceeds to block 221 where a transacting inquiry is sent from the consumer device 50 and merchant server 51, such as by clicking a “Buy” button on a merchant Web page. In an actual embodiment of the present invention, the Secure Socket Layer (“SSL”) protocol is used for establishing a secure connection. SSL uses public key encryption incorporated into the Web browser 64, to secure the information being transferred over the Internet. In response, a transaction offer digitally signed by the merchant is returned in block 222. The logic then proceeds to block 65 where the consumer authenticator component 65 on the consumer device 50 is executed. It will be appreciated that the consumer authenticator component 65 can also be included, in part or in whole, in the Web browser 64. The consumer authenticator component 65 is shown in more detail in FIG. 10 and described next.

The consumer authenticator 65 determines whether a consumer is a registered holder of a secure transaction account or put another way, a registered participant in the closed secure transaction system of the present invention. The logic of FIG. 10 begins in a block 243 and proceeds to a block 244 where an authentication request is received from the Web browser 64. The request includes: transaction information, such as product detail; identification of the parties, such as a consumer identification which identifies the consumer, e.g., the digital certificate issued to the consumer when he or she created the secure transaction account; and merchant identification, e.g., the digital certificate issued to the merchant upon creation of their merchant account; and context, such as transaction date and time. As stated earlier, embodiments of the invention implement the consumer authenticator 65 in the Web browser 64. In one actual embodiment, the consumer authenticator 65 is an applet or script operating from within the Web browser 64.

Next, in decision block 246, a test is made to determine if a digital certificate is installed on the consumer device 50. The digital certificate may be stored in the consumer device 50 memory 63, such as on the account records 66, or on some other device associated with the consumer device such as a secure token, a smart card or encrypted on some computer readable medium. It will be appreciated that other methods of digital identification can be used. If the digital certificate is installed, the digital certificate identification is inserted into an authentication container in block 248 and the authentication container is returned in block 250. The container can be any one of a variety of data formats, for example, in one embodiment of the present invention a proprietary protocol is used. In an actual embodiment of the present invention, a public key generated by the consumer's device and signed by the transaction server (thereby forming a digital certificate) is also inserted into the container. Secret keys are never transmitted across the network 41 in the secure transaction system of the present invention. The combination of the secret key and the digital certificate provides a heightened level of security to the consumer authentication process. A digital signature is generally a document that has been encrypted by the secret key of a public key pair. Only the public key of the same key pair will be able to decrypt the document to its original form. This is particularly useful in demonstrating that only the holder of the secret key is able to sign (or encrypt) the document. In practical terms, signing a large document using public key cryptography can be very time consuming. Almost equally effective is creating a cryptographic message digest (“hash”) of the document and then encrypting the hash with the secret key. Therefore those of ordinary skill in the art will appreciate that anyone knowing the corresponding public key and the digest algorithm will be able to verify that the message was not altered and that it originated from the holder of the corresponding secret key. It will be appreciated that the digital certificate as used herein refers to an authentication identifier that is recognized by the Transaction Authority that adheres to the Transaction Authority's non-repudiation transaction policies.

If, however, in decision block 246 it is determined that a digital certificate is not installed on the consumer device 50, the logic proceeds to a decision block 258 where a test is made to determine if the consumer wishes to apply for a secure transaction account. If the consumer wishes to apply for a secure transaction account, the logic proceeds to a block 260, in which the consumer is allowed to apply for a secure transaction account. Otherwise, the consumer authenticator 65 returns an unsuccessful authorization message in a block 261.

Referring back to FIG. 10, after the consumer has applied for a secure transaction account, the logic returns to decision block 246 where the test to determine if a digital certificate is now installed on the consumer device 50 is repeated and the logic proceeds as described above.

While the logic of authenticating a consumer as shown in FIG. 10 and described herein uses a digital certificate as the primary means for authenticating a consumer, it will be appreciated that other methods are possible. For example, a lesser level of security could be employed, whereby a user could be required to enter personal identifying information. Alternatively, a greater degree of security could be employed whereby a digital certificate is required, and “certificate not present” processing is not allowed. Or, an even greater level of security could be used requiring a supplemental digital signature and other verifying information from the consumer.

Returning to FIG. 9, after consumer authentication is completed in block 65, the logic proceeds to a decision block 226, where a test is made to determine if the consumer authentication was successful. If not, the logic proceeds to a block 227 where an error message is displayed on the consumer device 50 by the Web browser 64.

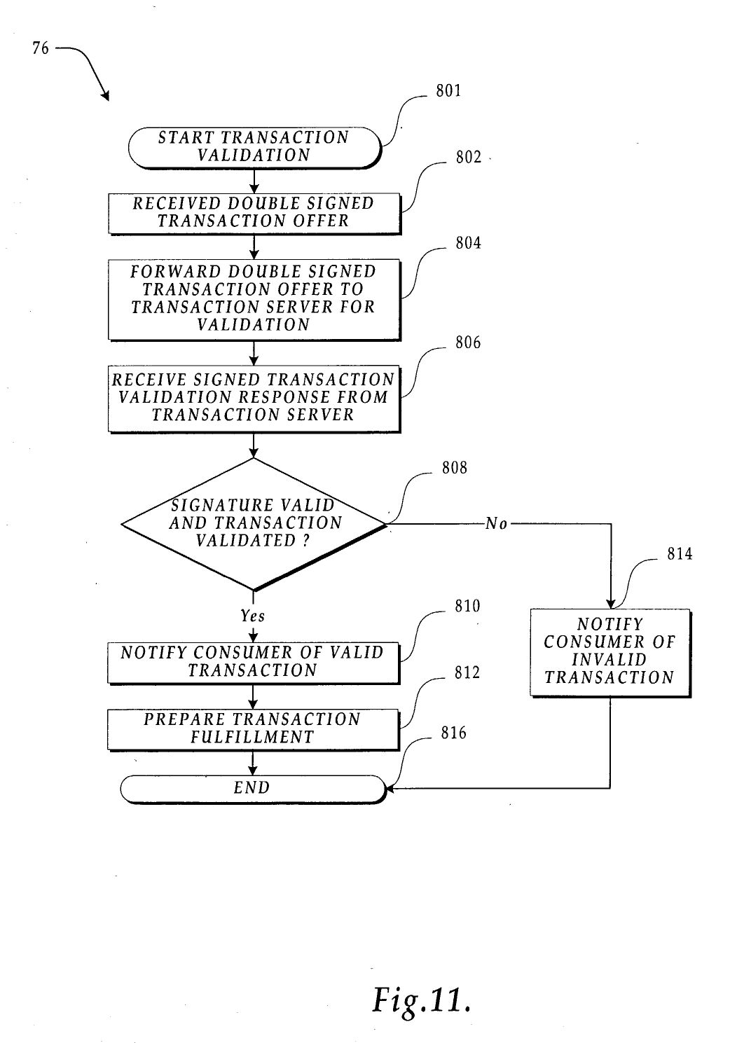

However, if the consumer was successfully authenticated, the logic proceeds from decision block 226 to block 228 where a secure transaction account selection Web page 1170 as shown in FIG. 6 is displayed. Included in the requested information of the secure transaction account selection Web page 1170 is an identification of the applicable account or sub-account to be used in the transaction. Next, in a block 230, sub-account and password information (used to unlock the consumer's digital certificate) are selected by the consumer from the information entered in the secure transaction account selection Web page 1170 of FIG. 6 when the consumer indicates that the information has been entered by selecting “Continue” 1177. The logic of FIG. 9 then proceeds to a block 232 where the transaction offer is digitally signed by the consumer and is then sent to the merchant server 51 in block 234 to be processed by the transaction server adapter 76 shown in FIG. 11 and described below.

The logic then proceeds to a block 236 where the logic waits to receive the transaction validation status from merchant server 51. Once the transaction validation status is received from the merchant server 51, the logic proceeds to decision block 238 where if the transaction was validated, a valid transaction message is displayed in block 240, otherwise in block 227 a transaction error message is displayed. In any case, the logic ends at block 242.

The logic of FIG. 11 begins in a block 801 and proceeds to a block 802 where the double signed transaction offer is received from the consumer device 50. The logic then proceeds to a block 804 where the double signed transaction offer is forwarded to the transaction server 52 for validation. A signed validation response is returned from the transaction server 52 in block 806. Next, in decision block 808, it is determined whether the transaction was validated and whether the Transaction Authority's signature was on the validated response. If the signature is valid and the transaction was validated, then the logic proceeds to block 810 where the consumer device is sent a valid transaction notice and the merchant device optionally prepares to fulfill the transaction (such as moving product from a warehouse or storage to a waiting facility) in block 812. If, however, in decision block 808 it was determined that the transaction was not validated and/or the Transaction Authority's signature was not on the validation response, in block 814 the consumer is notified of an invalid transaction. In any case, the logic of FIG. 11 ends at a block 814, and processing returns to FIG. 9.

The commerce engine 75 is the component of the merchant server 51 that determines whether or not the order will be processed and whether the requested product will ultimately be provided to the consumer. It will be appreciated that commerce engines are well known in the art. The commerce engine component 75 used in conjunction with the transaction server adapter 76 allows the secure transaction system of the present invention to expand existing technology that is currently used for traditional credit and payment systems to encompass the secure transaction account of the present system. It will be further appreciated that while the embodiment shown and described modifies the commerce engine to achieve this functionality (which may be possible through existing API calls of the commerce engine), other embodiments are possible.

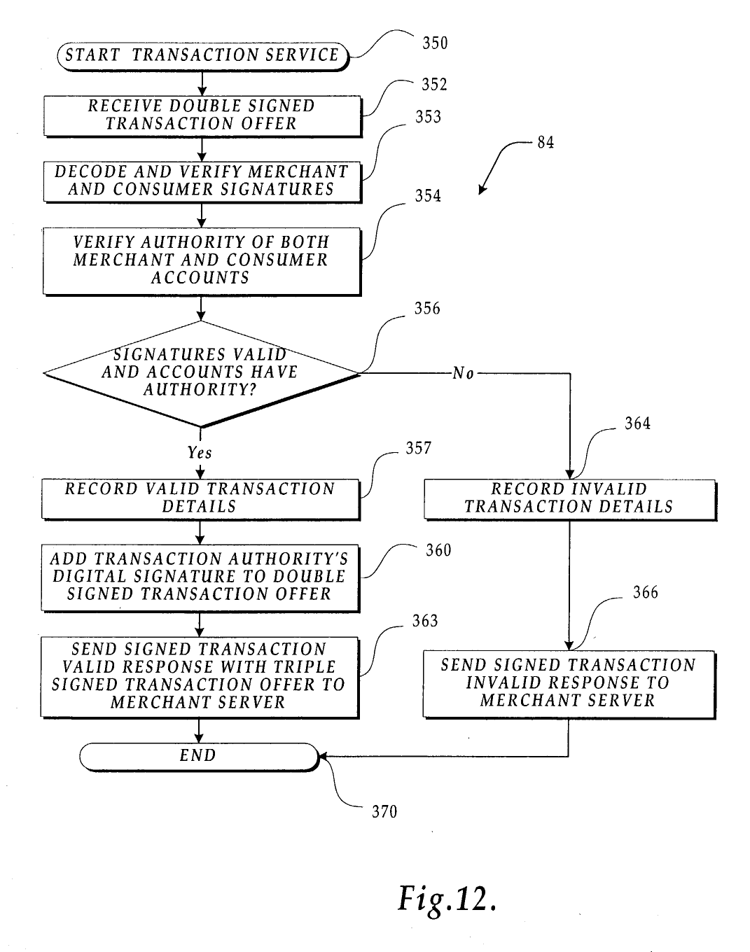

The transaction service component 84 of the transaction server 52 is responsible for interfacing with the other components of the system and determining whether or not a requested transaction should be allowed. One exemplary transaction service routine is illustrated in FIG. 12. The logic of FIG. 12 begins in a block 350 and proceeds to block 352 where the transaction offer with the merchant and consumer's signatures is received. Next, in block 353 the signatures are decoded and verified. The authority of both the consumer and merchant accounts is then checked in block 354 with reference to the account database 88. Next, the logic proceeds to decision block 356 where the results of block 353 and 354 are used to determine whether the requested transaction is permissible. A variety of factors can be considered in making the determination of whether a requested transaction is permissible. For example, spending limits cannot be exceeded, and user-imposed limitations, such as those put on a young shopper account, e.g., sites from which the young shopper can make purchases and hours during which the young shopper can make purchases cannot be violated.

If the transaction is not permissible, the logic transaction proceeds to a block 364 where the invalid transaction details are recorded to the transaction database 89. Then an invalid transaction response is sent to the requester (e.g., the merchant server 91) in block 366. The logic of FIG. 12 then ends in a block 370. If, however, in decision block 356 the transaction is found to be permissible, the logic proceeds to block 357 where valid transaction details are recorded to the transaction database 89.

The logic then proceeds to a block 360 where the double signed transaction offer is signed with the Transaction Authority digital signature to create a triple signed transaction offer. Then in block 363 a signed transaction valid response with the triple signed transaction offer is sent to the requester (e.g., the transaction server adapter 76 or the Web browser 64, whichever the case may be).

The logic of FIG. 12 ends in block 370 and processing returns to the requester.

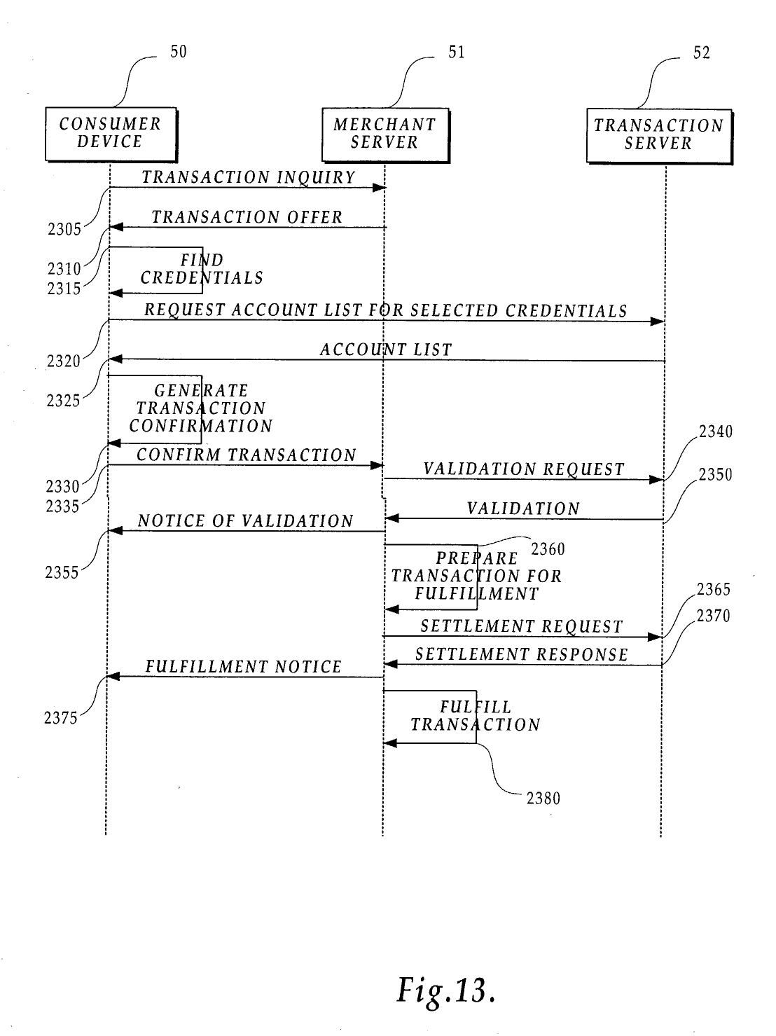

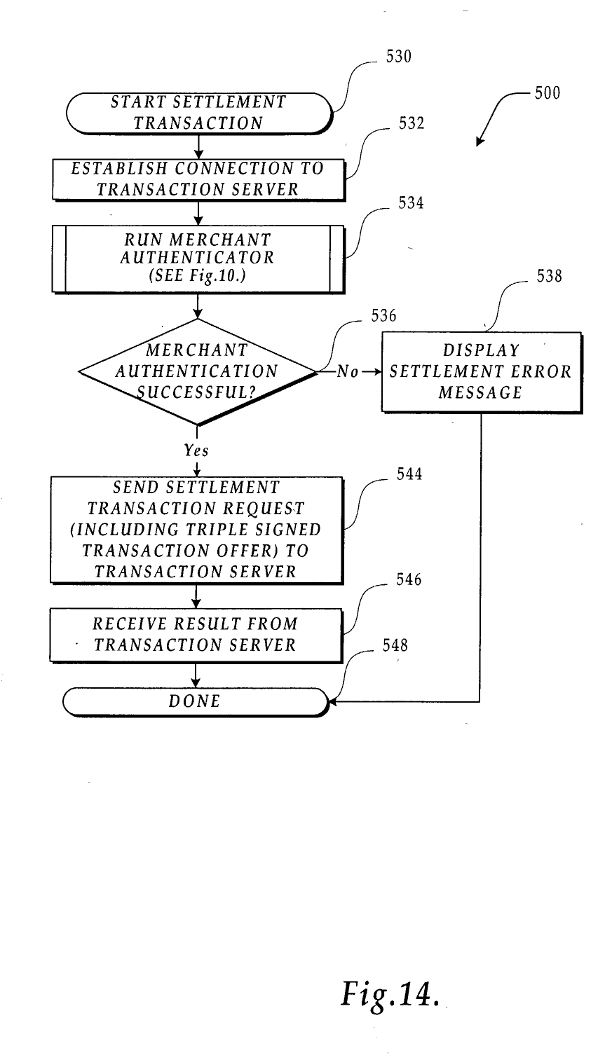

FIG. 13 is a diagram illustrating the actions taken by the consumer device 50, the merchant server 51 and the transaction server 52 for engaging in a transaction using one embodiment of the secure transaction account system of the present invention. This diagram presents a high-level view of the processing shown in the flow charts described above. In response to a transaction inquiry 2305, a merchant returns a transaction offer 2310 to the consumer's computer 50. To continue the consumer authenticator 65 looks for credentials, e.g. certificates, which are available to the consumer 2315. The consumer device 50 then requests a list of all accounts or sub-accounts 2320 for these credentials from the transaction server 52. The transaction server 52 returns only those accounts that are usable by the consumer 2325 using the found credentials. The consumer device 50 then generates a transaction confirmation (e.g., signs the transaction offer) 2330 using one of the accounts on the list returned from the transaction server 52. The consumer device 50 then sends the transaction confirmation 2335 to the merchant server 51. The merchant server 51 requests validation 2340 from the transaction server to verify that the transaction confirmation is valid. The transaction server 52 then returns a validation 2350 that the transaction is valid. The merchant server 51 may optionally then notify 2355 the consumer device 50 that the transaction was validated. The merchant server 51 then prepares the transaction for fulfillment 2360. At this point, the merchant may request a settlement transaction 2365 from the transaction server 52. The transaction server would then provide a settlement transaction 2370 back to the merchant server 51. The merchant server 51 may then notify 2375 the consumer device 50 of fulfillment details. Finally, the good(s), service(s) or other components of the transaction are fulfilled 2380.

In one alternate embodiment where the merchant is an auction provider, the authorization 2340 sent by the transaction server 52 to the merchant server 51 includes information such as a consumer account identification, a merchant identification, a merchant sale offering, a consumer authentication, a merchant authentication, and a master identification, i.e., identification of the Transaction Authority. Particular to this type of response is an expiration date/time that is used to signal the shorter of the maximum times that the consumer and the merchant are willing to “reserve” funds associated with this transaction. If the transaction, i.e., settlement request 2365, is not received by the transaction server 52 before the expiration date/time of the transaction, the products and/or funds will be released back to their owners. At a later time, once the consumer has committed to the purchase, the consumer releases an authorization to the provider of the transaction server 52 knowing that the merchant has the proven ability to ship the products on demand without delay. This initiates the actual settlement of funds and triggers payment to the merchant in the next settlement batch, without any further interaction with the merchant. This payment method supports consumer-initiated, pre-approved purchases with expiration date/time, such as auction and gift-certificate purchases.

It will be appreciated that FIG. 13 illustrates processing of a valid purchase transaction. If there is an error at any time during the processing, e.g., consumer is not authorized because he or she is not a registered consumer, has exceeded his or her spending limit, etc., processing will terminate after an appropriate error response has been returned to the consumer device 50 for display to the consumer via the Web browser 64.

### Merchant Reports

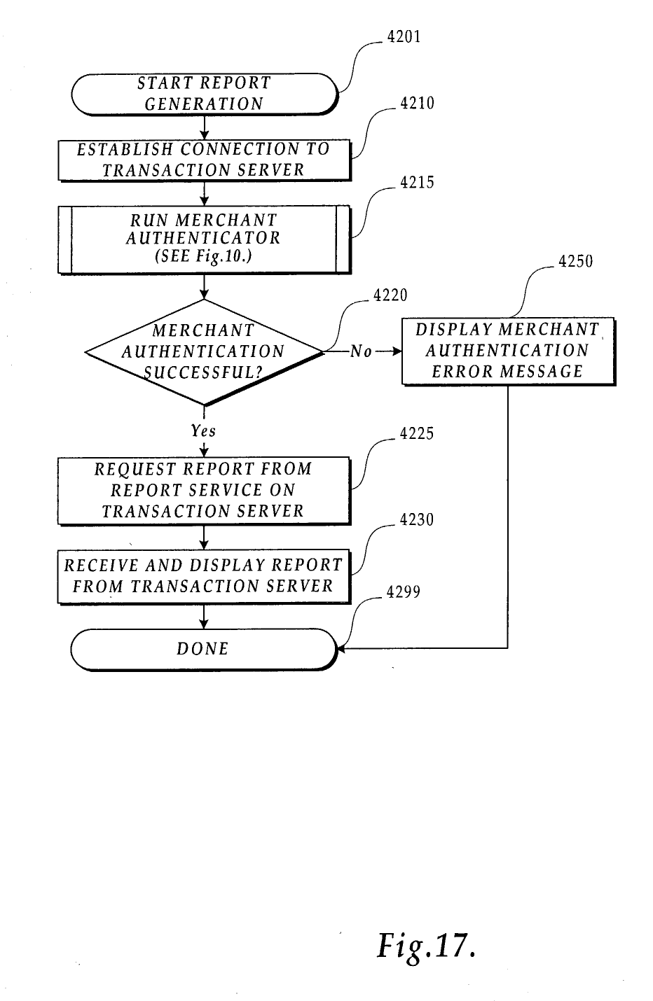

It is often desirable for merchant's to have detailed reports available to judge the current state of their business. Accordingly, the present invention maintains records of transactions in readily retrievable formats. It is also desirable that competitors not have access to the same reports on the details of a merchant's business. Additionally, the present invention provides for secure authenticated access to transaction reports. FIG. 17 illustrates the logic for generating merchant reports. The logic starts at a block 4201 and proceeds to a block 4210 that establishes a connection between the merchant computer 51 and the transaction server 52. The logic then proceeds to a block 77 where the merchant authenticator 77 of FIG. 10 is run to authenticate the merchant. The flow continues to decision block 4220 where a test is performed to see if the merchant has been authenticated. If the authentication was successful, the logic continues to a block 4225 where the merchant requests the report service 85 to generate a report. At a block 4230 the report service 85 returns the request transaction information in a report. The logic ends in a block 4299.

In one actual embodiment of the present invention, the transaction server 52 uses the transaction database 89 to store all transaction records. It will be appreciated by those of ordinary skill in the art, that a transaction database may be used to store information for report generation, yet may also store information relevant for other purposes.

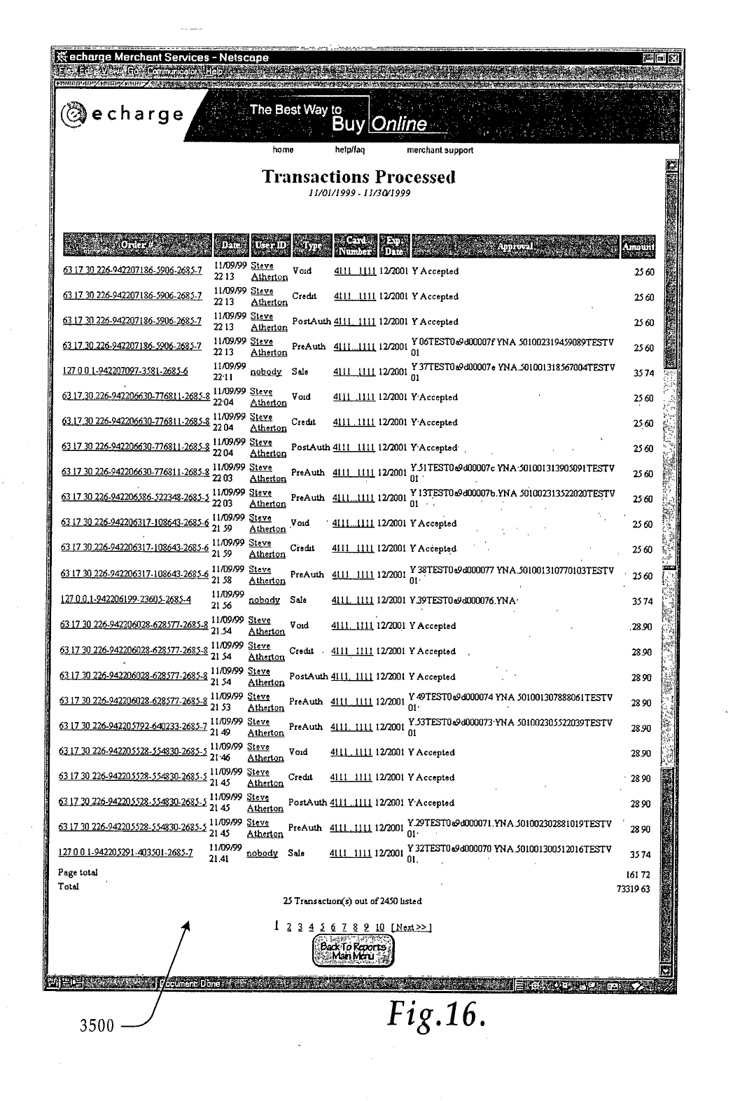

FIG. 16 illustrates an exemplary Web page 3500 illustrating exemplary transaction reports available to a merchant.

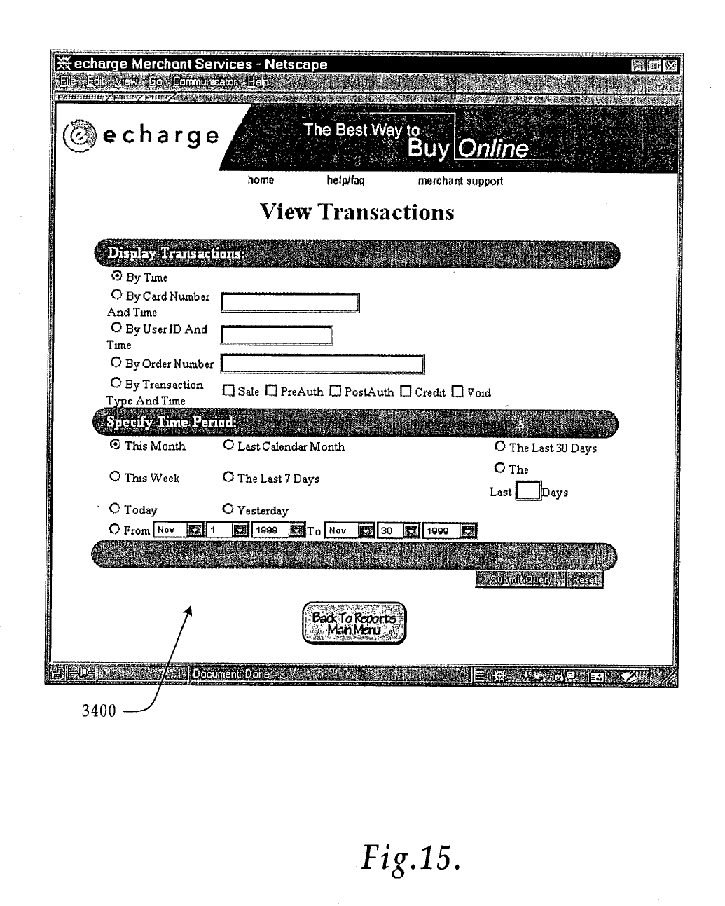

FIG. 15 illustrates an exemplary Web page form 3400 for customizing transaction reports.

In an alternate embodiment of the present invention, a merchant server 51 initiates a transaction by sending a request for a transaction identifier to the transaction server 52. The merchant server 51 digitally signs the request with a certificate that has been signed beforehand by the Transaction Authority. Upon receiving the request for a transaction identifier, the transaction server 52 checks the validity of the digital signature and the validity of the merchant's certificate.

The transaction server 52 then generates a new transaction identifier. This identifier is used to identify all further steps in the transaction and to differentiate the transaction from any other transactions between the parties. The identifier must also be sufficiently large and random such that it will not be readily repeatable in future transactions. The transaction server 52 may then activate the transaction identifier and set an expiration time when the transaction identifier will become inactive. The transaction server 52 then digitally signs the transaction identifier and expiration time with the Transaction Authority's certificate and sends the transaction identifier back to the merchant server 51.

The merchant then creates an “offer” for the consumer that includes the transaction identifier, the transaction expiration time, the merchant's name, the item(s), service(s), or other components of a transaction, any payment currency and any payment amount. The merchant server 51 then digitally signs the offer and sends it to the consumer device 50.

Before responding to the offer, the consumer device 50 digitally signs a request for their current account list with a certificate that has been signed by the Transaction Authority. The consumer then sends the account list request to the transaction server 52.

The transaction server 52 checks the validity of the digital signature on the account list request and the validity of the signing certificate. If both the certificate and the signature are valid, the transaction server 52 constructs an account list of all accessible accounts for the consumer and digitally signs the list. The transaction server 52 then sends the signed account list back to the consumer device 50.

The consumer device 50 receives the account list and validates that it has not been altered since coming from the transaction server 52 by checking the Transaction Authority's digital signature. The consumer then chooses an account from the account list to use in the current transaction. Using the chosen account, the consumer device 50 creates an accepted purchase contract and digitally signs it. The consumer device 50 then sends the signed contract to the merchant server 51.

Once the merchant has an accepted purchase contract, they forward it to the transaction server 52. The transaction server 52 checks the authenticity of both the merchant and the consumer's signatures and the corresponding certificates used to sign the contract.

If all the signatures and certificates are authenticated, and it is a purchase transaction, the transaction server 52 then checks to see if the consumer has available funds for the purchase. If there are sufficient funds available in the chosen account, the transaction server 52 reduces the “open-to-buy” amount for the chosen account by the purchase price. If there are sufficient funds or it is not a purchase transaction, but the signatures and certificate are valid, then the transaction server 52 creates and signs a validated contract. The validated contract is then sent back to the merchant server 51 as a digital receipt.

Once the merchant has the validated contract they are then able to request settlement of the transaction from the Transaction Authority, either immediately, or at some future date by sending a settlement request to the transaction server 52.

Once the transaction server 52 receives a settlement request, the request is checked for validity and if it is valid, the transaction server 52 responds in the manner called for in the settlement request, usually sending back a settlement response to the merchant.

It will be appreciated by those skilled in the art that the actions performed in the alternate embodiment above may be performed in other orders. For example, the consumer may request the transaction identifier and make an offer to the merchant. Alternatively, the consumer may not send an accepted purchase contract to the merchant, rather to the Transaction Authority and the Transaction Authority forwards only the validated contract to the merchant. It will also be appreciated that in yet other embodiments, multiple consumers or multiple merchants could use the present invention in a single transaction.

Although providing secure and authenticated purchase transactions is one of the more apparent uses for the present invention. It could also be used in other embodiments where similar authentication and security features are desirable. For example, the present invention could be used in a contract signing where both parties to the contract are distant to each other, yet they want to be sure that they both signed the same contract and that they are who they say they are.

According to another alternate embodiment of the present invention, a consumer, a merchant and a Transaction Authority are parties to a transaction. To initiate the transaction the merchant sends a request for a transaction identifier to the Transaction Authority. The Transaction Authority then generates a new transaction identifier. The Transaction Authority then sends the transaction identifier back to the merchant. The merchant then creates an “offer” that includes the transaction identifier and sends the offer to the consumer. Before responding to the offer, the consumer sends an account list request to the Transaction Authority. The Transaction Authority authenticates the request and then constructs an account list of all accessible accounts for the consumer and sends the account list back to the consumer. The consumer receives the account list and then chooses an accessible account to use in the current transaction. Using the chosen account, the consumer responds to the merchant with an accepted purchase contract. Once the merchant has an accepted purchase contract, they forward it to the Transaction Authority who validates the contract and returns the validated contract back to the merchant. Once the merchant has a validated contract they are then able to request settlement of the transaction from the Transaction Authority, either immediately, or at some future date by sending a settlement request to the Transaction Authority. Once the Transaction Authority receives a settlement request, the request is checked for validity and if it is valid, the Transaction Authority responds in the manner called for in the settlement request, usually sending back a settlement response to the merchant.

In an exemplary embodiment showing a general contract signing using the secure transaction, the parties are merchant, consumer and Transaction Authority; the steps are as follows:

A merchant initiates a contract by sending a request for a contract identifier to the Transaction Authority. The merchant digitally signs the request with a certificate that has been signed beforehand by the Transaction Authority. Upon receiving the request for a contract identifier, the Transaction Authority checks the validity of the digital signature and the validity of merchant's certificate.

The Transaction Authority then generates a new contract identifier. This identifier is used to identify all further steps in the contract and to differentiate the contract from any other contracts between the parties. The identifier must also be sufficiently large and random such that it will not be readily repeatable in future contracts. The Transaction Authority then activates the identifier and sets an expiration time when the identifier will become inactive. The Transaction Authority then digitally signs the identifier and expiration time with the Transaction Authority's certificate and sends the contract identifier back to the merchant.

The merchant then creates an “offer” for a consumer that includes the contract identifier, the contract expiration time, the merchant's name and the terms of the contract. The merchant then digitally signs the offer and sends it to consumer.

Before responding to the offer, the consumer digitally signs a request for their current account list (different certificates may be used to retrieve different accounts or to sign different types of contracts, depending on consumer's role at the time) with a certificate that has been signed by the Transaction Authority. The consumer then sends the certificate list request to the Transaction Authority.

The Transaction Authority checks the validity of the digital signature on the account list request and the validity of the signing certificate. If both the certificate and the signature are valid, the Transaction Authority constructs an account list of all accessible accounts for consumer and digitally signs the list. The Transaction Authority then sends the signed account list back to the consumer.

The consumer receives the account list and validates that it has not been altered since coming from the Transaction Authority by checking the digital signature. The consumer then chooses an accessible certificate to use in the current contract. Using the chosen certificate, the consumer creates an accepted contract and digitally signs it. The consumer then sends the signed contract to merchant.

Once the merchant has an accepted contract, he forwards it to the Transaction Authority. The Transaction Authority checks the authenticity of both merchant and consumer's signatures and the corresponding certificates used to sign the contract.

If all the signatures and certificates are authenticated, the Transaction Authority then checks to see if the consumer has the authority to sign this type of contract with the certificate used. If the consumer did have authority to use that certificate to sign the contract, the Transaction Authority records the contract for that certificate and proceeds. The Transaction Authority then creates and signs a validated contract. The validated contract is then sent back to the merchant.

Once the merchant has the validated contract they are then able to request settlement of the contract from the Transaction Authority, either immediately, or at some future date by sending a settlement request to the Transaction Authority.

Once the Transaction Authority receives a settlement request, the request is checked for validity and if it is valid, the Transaction Authority responds in the manner called for in the settlement request, usually sending back a settlement response to merchant.

While the preferred embodiment of the invention has been illustrated and described, it will be appreciated that various changes can be made therein without departing from the spirit and scope of the invention. In particular, it will be appreciated by those of ordinary skill in the art that this secure transaction protocol would be applicable to other authentication and security applications as well.

The embodiments of the invention in which an exclusive property or privilege: is claimed are defined as follows:

1. A method for engaging in a secure transaction with a merchant server using a secure transaction account, comprising:
receiving a request from a consumer device to engage in a transaction with said merchant server using said secure transaction account;
in response to said transaction request, determining whether said consumer device is associated with said secure transaction account;
in response to determining that said consumer device is associated with said secure transaction account, initiating a secure transaction between said consumer device and said merchant server; and
fulfilling a purpose of said secure transaction for a consumer associated with said consumer device.

2. The method of claim 1, wherein determining whether said consumer device is associated with said secure transaction account comprises: transmitting an authentication request from said consumer device to a transaction server; determining at said transaction server whether said secure transaction account is associated with said consumer device; and transmitting an account identification container to said consumer device in response to determining that said consumer device is associated with a valid secure transaction account.

3. The method of claim 2, wherein determining at said transaction server whether said secure transaction account is associated with said consumer device further comprises determining at said transaction server whether said secure transaction account is valid.

4. The method of claim 2, wherein said authentication request comprises a digital certificate.

5. The method of claim 4 further comprising retrieving said digital certificate from a secure token.

6. The method of claim 1, wherein said secure transaction account comprises a main account and at least one sub-account.

7. The method of claim 6, wherein said sub-account is operative only to accept charges from a predetermined list of merchant servers.

8. The method of claim 6, wherein a authority limit may be set by said consumer for said sub-account.

9. A method for engaging in a secure transaction with a merchant server using a secure transaction account associated with a consumer device, comprising:
receiving a request from a consumer device to engage in a transaction with said merchant server using said secure transaction account;
in response to said transaction request, transmitting an validation request to a transaction server;
in response to a positive validation from said transaction server, initiating a secure transaction between said consumer device and said merchant server; and
fulfilling a purpose of said secure transaction for a consumer associated with said consumer device.

10. The method of claim 9, wherein said authentication request comprises a digital certificate, and wherein said digital certificate is transmitted to said transaction server.

11. A method for settling at least one secure transaction, the method comprising:
receiving at least one settlement transaction request from a merchant server;
determining that said at least one settlement transaction request is permissible;
in response to determining that said at least one settlement transaction request is permissible, processing said at least one settlement transaction request;
in response to processing said at least one transaction request, adjusting a merchant account associated with said merchant server.

12. The method of claim 11, wherein said at least one settlement transaction request is substantially contemporaneous with at least one associated secure transaction.

13. The method of claim 11, wherein said at least one settlement transaction request is delayed for a predetermined period of time after at least one associated secure transaction.

14. A method for generating a report comprising receiving a report request from a merchant server using a secure transaction account;
in response to said report request, determining whether said merchant server is associated with said secure transaction account;
in response to determining that said merchant server is associated with said secure transaction account, generating a report; and
transmitting said report to said merchant server.

15. The method of claim 14, wherein determining whether said merchant server is associated with said secure transaction account comprises: transmitting an authentication request comprising a digital certificate from said merchant server to a transaction server; determining at said transaction server whether said secure transaction account is valid; determining at said transaction server whether said secure transaction account is associated with said merchant server; and transmitting an account identification container comprising said digital certificate to said merchant server in response to determining that said merchant server is associated with a valid secure transaction account.

16. A system for engaging in a secure transaction, comprising:
a consumer device operative to engage in a secure transaction using a secure transaction account; and
a merchant server operative to:
receive a request from a consumer device to engage in a transaction with said merchant server using said secure transaction account;
in response to said transaction request, determine whether said consumer device is associated with said secure transaction account;
in response to determining that said consumer device is associated with said secure transaction account, initiate a secure transaction between said consumer device and said merchant server; and
fulfill a purpose of said secure transaction for a consumer associated with said consumer device.

17. The system of claim 16, further comprising:
a secure token associated with said consumer device; and
said merchant server is further operative to:
determine whether said consumer device is associated with said secure transaction account by retrieving a digital certificate from said secure token; and transmit an authentication request including said digital certificate to a transaction server; and
said transaction server is operative to:
determine whether said secure transaction account is valid;
determine whether said secure transaction account is associated with said consumer device; and
transmit an account identification container to said consumer device in response to determining that said consumer device is associated with a valid secure transaction account.

18. The system of claim 16, further comprising a transaction server operative to: apply a cost of said product to said secure transaction account also: receiving an account identifier associated with said secure transaction account from said merchant server; determining whether said secure transaction account is valid to engage in secure transactions; and in response to determining that said secure transaction account is valid, transmitting a valid transaction authorization from said transaction server to said merchant server.

19. A computer-readable medium having an computer executable component for performing the method of any of claims 1-8.

20. A computer-readable medium having an computer executable component for performing the method of any of claims 9-10.

21. A computer-readable medium having an computer executable component for performing the method of any of claims 11-13.

22. A computer-readable medium having an computer executable component for performing the method of any of claims 14-15.
